(19) United States
(12) Patent Application Publication
(10) Pub. No.: US 2023/0299256 A1
(43) Pub. Date: Sep. 21, 2023

(54) EVALUATION METHOD AND PRODUCTION METHOD OF COATED ACTIVE MATERIAL PARTICLES, AND METHOD OF PRODUCING ELECTRODE

(71) Applicant: TOYOTA JIDOSHA KABUSHIKI KAISHA, Toyota-shi (JP)

(72) Inventor: Aiko NAGANO, Nisshin-shi (JP)

(73) Assignee: TOYOTA JIDOSHA KABUSHIKI KAISHA, Toyota-shi (JP)

(21) Appl. No.: 18/091,859

(22) Filed: Dec. 30, 2022

(30) Foreign Application Priority Data
Mar. 16, 2022 (JP) 2022-041737

(51) Int. Cl. H01M 4/04

(52) U.S. Cl. CPC H01M 4/0404

(57) ABSTRACT

The evaluation method in the present disclosure is a method of evaluating a coating state of coated active material particles including active material particles and a coating layer that covers the surface of the active material particles. The evaluation method in the present disclosure is an evaluation method including acquiring an SEM image of the coated active material particles when a negative voltage is applied to the coated active material particles (in a retarding mode), detecting whether there is a coating layer on the surface of the active material particles based on a contrast in the SEM image, and evaluating the coating state.

### CROSS-REFERENCE TO RELATED APPLICATION

This application claims priority to Japanese Patent Application No. 2022-041737 filed on Mar. 16, 2022, incorporated herein by reference in its entirety.

### BACKGROUND

### 1. Technical Field

The present disclosure relates to an evaluation method and a production method of coated active material particles, and a method of producing an electrode.

### 2. Description of Related Art

As an active material used in production of batteries such as an all-solid-state secondary battery and a liquid secondary battery, coated active material particles obtained by providing a coating layer on the surface of active material particles (positive electrode active material particles or negative electrode active material particles) are known.

For such coated active material particles, a method of measuring the coating state (coverage) of the surface of coated active material particles by image analysis of transmission electron microscope (TEM) images, X-ray photoelectron spectroscopy (XPS) analysis or the like is known.

However, since image analysis of TEM images is local observation (for example, in a range smaller than 1 square nm), it is not possible to measure the coating state of coated active material particles in the entire electrode (electrode mixture layer) composed of a plurality of coated active material particles.

In addition, in XPS analysis, since the average composition in the range from the surface to a depth of 3 nm to 10 nm is measured, even if there is a part not covered with active material particles, if a thick coating layer partially exists, it is assumed that the active material particles are coated as a whole. Therefore, it is difficult to accurately measure the coating state of coated active material particles. For example, in XPS analysis, it is not possible to distinguish between left and right coating states in FIG. 7A and FIG. 7B.

As described above, in the related art, since the coating state was measured based on local information (TEM) or average information (XPS), it was not possible to accurately determine the coating state of active material particles.

In addition, Japanese Unexamined Patent Application Publication No. 2018-206619 (JP 2018-206619 A) discloses a method of measuring the coating state (coverage) of coated active material particles using image analysis of low-acceleration SEM images.

### SUMMARY

According to the method of JP 2018-206619 A, when the accelerating voltage of primary electrons in SEM observation is lowered, since primary electrons are unlikely to enter the inside of coated active material particles, it is possible to obtain SEM images reflecting detailed information on the surface of coated active material particles.

However, the inventors found that, even if image analysis of low-acceleration SEM images is used as in JP 2018-206619 A, it may be difficult to measure the coating state depending on the positive electrode active material, the material of the coating layer, the thickness of the coating layer or the like. Specifically, for example, it has been found that, when the atomic numbers of elements contained in the positive electrode active material and the material constituting the coating layer is relatively close or when the thickness of the coating layer is very thin, it is difficult to accurately measure the coating state by image analysis of low-acceleration SEM images.

The present disclosure is provided to improve the measurement accuracy of an overall coating state of coated active material particles including active material particles and a coating layer that covers the surface of the active material particles.

(1) An evaluation method evaluates a coating state of coated active material particles including active material particles and a coating layer that covers the surface of the active material particles, the method including acquiring an SEM image of the coated active material particles when a negative voltage is applied to the coated active material particles (in a retarding mode), detecting whether there is a coating layer on the surface of the active material particles based on a contrast in the SEM image, and evaluating the coating state.

According to the evaluation method (1), when SEM observation is performed in a retarding mode, the voltage (emitting voltage) of primary electrons emitted to the coated active material particles is lowered to obtain accurate information on the surface of the coated active material particles and thus it is not necessary to reduce the amount of primary electrons emitted to the coated active material particles (refer to FIG. 5). Therefore, it is possible to obtain accurate information on the surface of the coated active material particles with high sensitivity. Therefore, it is possible to improve the measurement accuracy of an overall coating state of the coated active material particles including active material particles and a coating layer that covers the surface of the active material particles.

(2) The evaluation method according to (1), wherein an emitting voltage of primary electrons when the SEM image is acquired is 0.1 kV to 1.0 kV.

According to the evaluation method (2), it is possible to more reliably improve the measurement accuracy of an overall coating state of the coated active material particles.

(3) The evaluation method according to (1) or (2), wherein the coating layer contains a conductive material.

According to the evaluation method (3), it is possible to more reliably improve the measurement accuracy of an overall coating state of the coated active material particles.

(4) A method of producing coated active material particles including active material particles and a coating layer that covers at least a part of the surface of the active material particles, the method including: a coating process in which a coating layer is formed on the surface of the active material particles to obtain the coated active material particles; and an evaluating process in which a coating state of the coated active material particles obtained in the coating process is evaluated using the evaluation method according to any one of (1) to (3).

According to the method of producing coated active material particles (4), since it is possible to improve the measurement accuracy of an overall coating state of the coated active material particles, it is possible to obtain coated active material particles having a favorable coating state using information on the evaluation result of the coating state.

(5) A method of producing an electrode including an electrode mixture layer containing coated active material particles including active material particles and a coating layer that covers at least a part of the surface of the active material particles, the method including: a process in which the electrode mixture layer containing the coated active material particles is formed; and an evaluating process in which a coating state of the coated active material particles contained in the electrode mixture layer is evaluated using the evaluation method according to any one of (1) to (3).

According to the method of producing an electrode (5), since it is possible to improve the measurement accuracy of an overall coating state of the coated active material particles, it is possible to obtain an electrode having a favorable coating state of the coated active material particles using information on the evaluation result of the coating state.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing an SEM image obtained in Example 1;

FIG. 2 is a partially enlarged view of the SEM image obtained in Example 1;

FIG. 3 is a diagram showing an SEM image obtained in Comparative Example 1;

FIG. 4 is a diagram showing an EDS qualitative analysis chart for active material particles with a high coverage (B) and active material particles with a low coverage (A) shown in FIG. 2;

FIG. 5 is a schematic view for illustrating an evaluation method (method using low-acceleration SEM images in a retarding mode) according to an embodiment;

FIG. 6 is a schematic view for illustrating an evaluation method (a method using low-acceleration SEM images in a normal mode) in the related art;

FIG. 7A is a schematic view for illustrating a problem of an evaluation method (XPS) in the related art; and

FIG. 7B is a schematic view for illustrating a problem of an evaluation method (XPS) in the related art.

### DETAILED DESCRIPTION OF EMBODIMENTS

Hereinafter, one embodiment of the present disclosure will be described. However, the present disclosure is not limited thereto. Here, in this specification, “positive electrode” and “negative electrode” are collectively referred to as “electrode.”

Method of Evaluating Coated Active Material Particles

In a method of evaluating coated active material particles according to the present embodiment, in a state (retarding mode) in which a negative voltage (retarding voltage) is applied to coated active material particles, a scanning electron microscope (SEM) image of the coated active material particles is acquired, and based on the contrast in the SEM image, it is detected whether there is a coating layer on the surface of active material particles, and the coating state is evaluated.

The coated active material particles include active material particles and a coating layer that covers the surface of the active material particles. The active material particles are, for example, positive electrode active material particles or negative electrode active material particles for batteries.

When the active material particles are positive electrode active material particles, the positive electrode active material particles may include, for example, at least one selected from the group consisting of lithium cobaltate, lithium nickelate (NCA), lithium manganate, nickel cobalt lithium manganite (for example, Li_{1.15}Ni_{1/3}Co_{1/3}Mn_{1/3}O₂), nickel cobalt lithium aluminate, and lithium iron phosphate.

The coating layer preferably contains a conductive material. In this case, it is possible to more reliably improve the measurement accuracy of the overall coating state of coated active material particles. This is because the coating state can be evaluated based on the contrast difference in SEM images resulting from a potential difference according to inclusion of the conductive material (that is, a material whose potential difference can be used as an index). The conductive material is not particularly limited, and examples thereof include Nb.

The coating layer may contain, for example, a Li-ion conductive oxide such as lithium niobate (LiNbO₃). In addition, the coating layer can function, for example, as a buffer layer in the electrode of an all-solid-state battery, in order to reduce a volume change due to expansion and contraction of active material particles and solid electrolyte particles.

The coated active material particles can be prepared by coating active material particles with a coating layer by various known coating methods.

The SEM used in the present embodiment is not particularly limited, for example, and may be an SEM using a thermionic emission electron gun or an SEM using a field emission electron gun (FE-SEM: field emission scanning electron microscope). When the FE-SEM is used, it is possible to evaluate more accurately the coating state of active material particles.

“Retarding mode” is a mode in which a negative voltage (retarding voltage) is applied to a sample to be observed (coated active material particles), and thus a primary electron beam is decelerated in front of the sample. The method of acquiring an SEM image in the “retarding mode” is called a retarding method (deceleration method). In the retarding method, an electron beam (primary electrons) accelerated by an electron gun is decelerated by electrostatic electrolysis (deceleration electrolysis) in front of the sample (for example, between the sample and the beam column) (refer to FIG. 5).

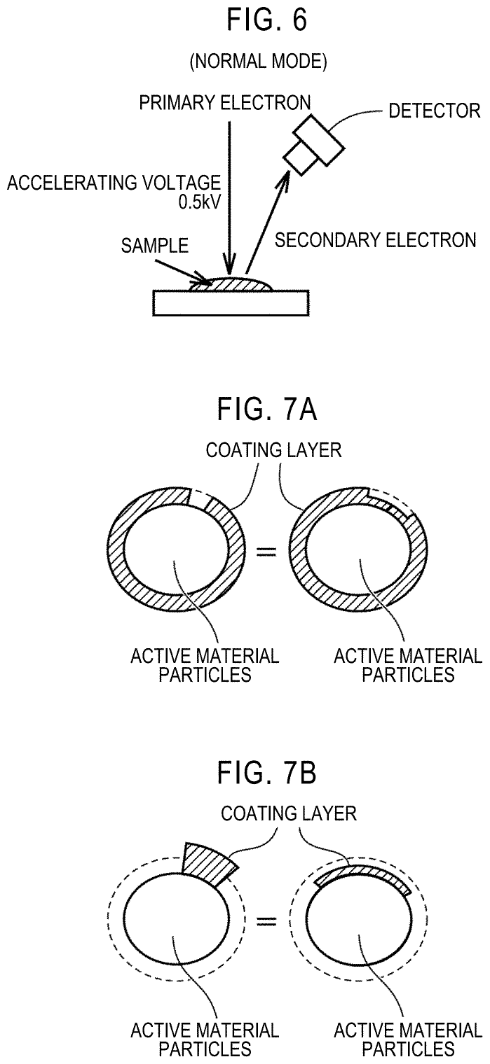

Here, when SEM observation is performed in the normal mode at a low accelerating voltage, the amount of primary electrons is reduced by lowering the accelerating voltage (that is, emitting voltage) of primary electrons, and thus the sensitivity decreases (refer to FIG. 6). On the other hand, in the retarding method, when the emitting voltage is lowered by decelerating the primary electron beam in front of the sample, since it is not necessary to lower the accelerating voltage of primary electrons, it is possible to maintain the amount of primary electrons emitted (refer to FIG. 5). Therefore, according to the retarding method, it is possible to detect accurate information on the surface of the sample (coated active material particles) without lowering the sensitivity.

The coating layer provided on active material particles for batteries (positive electrode active material particles, etc.) is required to be thin (for example, an average thickness of 10 nm). Here, in the case of a liquid battery, when an additive is added to an electrolytic solution, a coating layer with a relatively uniform thickness is formed by charging and discharging, but in the case of an all-solid-state battery, since active material particles are directly coated, it is difficult to maintain a uniform coating state. Therefore, particularly, regarding coated active material particles for all-solid-state batteries, it is desirable to evaluate (inspect) the coating state.

In order to obtain accurate information on the coating state with such a thin coating layer, in SEM observation conditions in the normal mode, a large amount of information about active material particles inside the coated active material particles is obtained even in low-acceleration SEM observation, and accurate information on the coating state is not obtained. Therefore, the evaluation method of the present embodiment is particularly useful when accurate information on the coating state with such a thin coating layer is obtained.

In addition, in the SEM image obtained by the retarding method, since a negative voltage is applied to a sample stage, the contrast difference resulting from a potential difference of a target sample is larger than in the normal mode. Therefore, in the coated active material particles, even if the atomic numbers of elements constituting the coating layer and the atomic numbers of elements constituting positive electrode active material particles are relatively close, it is possible to distinguish the coated part and the non-coated part according to the contrast difference based on the potential difference between the coating layer and the positive electrode active material particles. Accordingly, in the present embodiment, it is preferable to evaluate the coating state of coated active material particles based on the contrast difference resulting from a potential difference.

Here, in the evaluation method of the present disclosure, since information about a potential (conductivity) difference can be obtained in this manner, there is also an advantage of information about battery performance related to conductivity such as battery resistance being obtained.

In the evaluation method of the present embodiment, for example, based on evaluation criteria in which “coating is favorable” when the measured coverage is a predetermined threshold value or more and “coating is poor” when the measured coverage is less than the threshold value, it is possible to evaluate the coating state for each coated active material particle.

In addition, for example, it is possible to determine whether the electrode is a not-defective product using a proportion of active material particles with a high coverage (favorable coating) in the electrode mixture layer constituting the electrode.

The emitting voltage (accelerating voltage and retarding voltage) of primary electrons when an SEM image is obtained is preferably adjusted so that the contrast difference between the active material particles and the coating layer is sufficiently large. Although it varies depending on the type of the active material particles and the coating layer or the like, the emitting voltage is preferably 0.1 kV to 1.0 kV, and more preferably 0.2 kV to 0.5 kV. If the emitting voltage is higher than this, not only information on the surface of coated active material particles but also information on the inside thereof is obtained, the contrast difference between the coated part and the non-coated part becomes small, and it is difficult to accurately measure the coating state. If the emitting voltage is lower than this, the amount of primary electrons emitted to the coated active material particles decreases, and the amount of secondary electrons detected also decreases, an thus the measurement sensitivity decreases.

Here, the emitting voltage is basically “[accelerating voltage of primary electrons]−[retarding voltage],” and the emitting voltage can be adjusted by controlling the accelerating voltage and the retarding voltage of primary electrons.

Although the accelerating voltage is not particularly limited, it is preferably 2 kV or less in order to reduce damage to the sample (coated active material particles).

The retarding voltage is, for example, 1.9 kV or less.

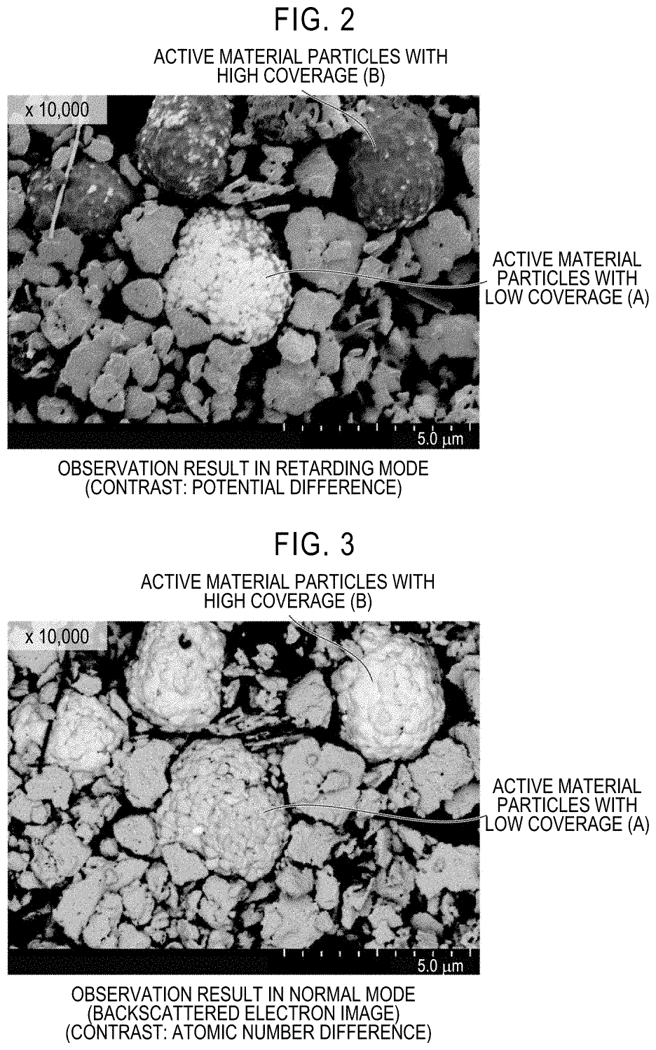

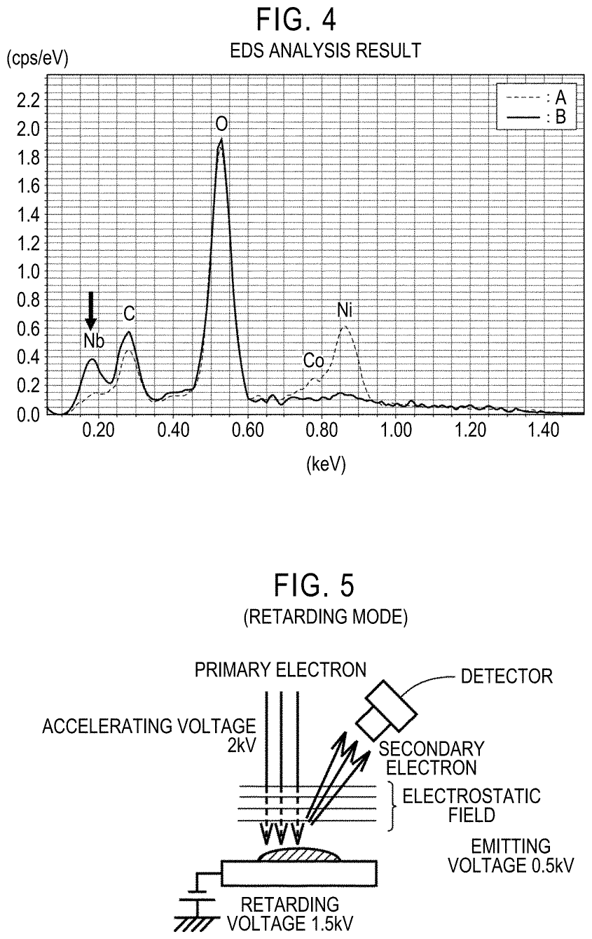

Here, FIG. 4 shows an EDS qualitative analysis chart for active material particles with a high coverage (B) and active material particles with a low coverage (A) shown in FIG. 2. In FIG. 4, in the chart of the active material particles with a low coverage (A) (white active material particles), a peak derived from NCA (Ni, Co) which is a material of the active material particles is confirmed. On the other hand, in the chart of the active material particles with a high coverage (B) (black active material particles), a peak derived from Nb contained in the coating layer is confirmed. Accordingly, in the present embodiment, it can be understood that the evaluation result of the coating state of the active material particles based on the contrast of the SEM image matches the elemental analysis result by EDS.

Here, in principle, it is conceivable to use a method in which SEM observation and energy dispersive X-ray spectroscopy (EDS, EDX, XEDS, etc.) are combined to evaluate the coating state of coated active material particles. In this method, the results of elemental analysis such as EDS are used. However, in order to obtain information on the outermost surface of the coated active material particles by EDS or the like and to obtain an element mapping image, it usually takes 1 hour or more simply with one field of view. In addition, in order to obtain overall information about raw material powders and electrodes composed of the coated active material particles, it is necessary to measure a plurality of fields of view which requires an enormous amount of time for measurement. Therefore, it is not realistic to evaluate the coating state of the coated active material particles by such a method. Here, a method of analyzing only one specific point for each particle is also conceivable, but in order to obtain overall information about electrodes and the like, it is necessary to measure a large number of particles, which also requires an enormous amount of time for measurement.

On the other hand, since the method of evaluating coated active material particles according to the present embodiment requires a short observation time and is simple, it is possible to quickly evaluate the coating state of active material particles. Therefore, when the evaluation method of the present embodiment is used, for example, regarding the coated active material particles used as the raw material of the electrode and the electrode (electrode mixture layer) produced using the coated active material particles, it is possible to easily evaluate (inspect) whether the coating state of the active material particles is favorable or poor.

Method of Producing Coated Active Material Particles

In the method of producing coated active material particles according to the present embodiment, coated active material particles including active material particles and a coating layer that covers at least a part of the surface of the active material particles are produced.

The method of producing coated active material particles according to the present embodiment includes at least a coating process in which a coating layer is formed on the surface of active material particles to obtain coated active material particles and an evaluating process in which the coating state of the coated active material particles obtained in the coating process is evaluated using the evaluation method.

In the method of producing coated active material particles according to the present embodiment, since it is possible to improve the measurement accuracy of the overall coating state of the coated active material particles by the evaluation method, it is possible to obtain coated active material particles having a favorable coating state using information on the evaluation result of the coating state.

The method of producing coated active material particles according to the present embodiment may include, for example, a selecting process in which, regarding a powder raw material composed of coated active material particles, a powder raw material in which the proportion of coated active material particles of which the coating state is evaluated as not favorable by the evaluation method is more than a predetermined threshold value is excluded. According to such a process, it is possible to provide a powder raw material having a favorable coating state of the coated active material particles.

In addition, for example, the evaluation result is fed back and coated active material particle production conditions are adjusted so that the proportion of coated active material particles of which the coating state is evaluated as not favorable becomes small, and thus a raw material powder in which the coating state of coated active material particles is favorable may be obtained.

Method of Producing Electrode

In the method of producing an electrode of the present embodiment, an electrode including an electrode mixture layer containing coated active material particles is produced. The coated active material particles include, similarly to the above, active material particles and a coating layer that covers at least a part of the surface of the active material particles.

The method of producing an electrode of the present embodiment includes at least a process in which an electrode mixture layer containing coated active material particles is formed and an evaluating process in which the coating state of the coated active material particles contained in the electrode mixture layer is evaluated using the evaluation method.

According to the method of producing an electrode of the present embodiment, since it is possible to improve the measurement accuracy of the overall coating state of the coated active material particles by the evaluation method, it is possible to obtain an electrode having a favorable coating state of the coated active material particles using information on the evaluation result of the coating state.

Here, in the evaluating process, the coating state of the coated active material particles contained in the electrode mixture layer is evaluated, for example, by image analysis of the SEM image of the surface of the electrode mixture layer.

The method of producing an electrode of the present embodiment may include, for example, a selecting process in which an electrode in which the proportion of coated active material particles of which the coating state is evaluated as not favorable by the evaluation method is more than a predetermined threshold value is excluded. According to such a process, it is possible to obtain an electrode having a favorable coating state of the coated active material particles.

In addition, for example, the evaluation result is fed back and coated active material particle production conditions are adjusted so that the proportion of coated active material particles of which the coating state is evaluated as not favorable becomes small, and thus an electrode having a favorable coating state of the coated active material particles may be obtained.

According to the method of producing coated active material particles and the method of producing an electrode, based on the evaluation results of the state of the coated active material particles and the electrode without performing an evaluation test on the finally produced battery, it is possible to easily obtain a not-defective electrode (an electrode having a favorable coating state of the coated active material particles).

Here, in the present embodiment, the electrode may be a positive electrode or a negative electrode.

The electrode is, for example, a positive electrode including a positive electrode current collector foil and a positive electrode mixture layer. The positive electrode current collector foil may be, for example, an aluminum (Al) foil.

The positive electrode mixture layer contains at least a positive electrode active material. For example, the positive electrode mixture layer may be substantially composed of a positive electrode active material. The positive electrode mixture layer may contain, for example, a conductive material and a binder, in addition to the positive electrode active material.

The positive electrode active material includes the coated active material particles.

The conductive material may include, for example, a conductive carbon material [for example, vapor grown carbon fibers (VGCF)].

The binder may contain, for example, polyvinylidene fluoride (PVdF).

In addition, the electrode is, for example, a negative electrode including a negative electrode current collector foil and a negative electrode mixture layer. The negative electrode current collector foil may be, for example, a copper (Cu) foil or a nickel (Ni) foil.

The negative electrode mixture layer contains at least a negative electrode active material. For example, the negative electrode mixture layer may be substantially composed of a negative electrode active material. The negative electrode mixture layer may contain, for example, a conductive material and a binder, in addition to the negative electrode active material.

The negative electrode active material may contain, for example, at least one selected from the group consisting of graphite, soft carbon, hard carbon, silicon, silicon oxide, silicon-based alloys, tin, tin oxide, tin-based alloys, and lithium titanate (Li₄Ti₅O₁₂).

The coated active material particles and electrode obtained by the production method of the present disclosure can be used, for example, in secondary batteries such as a lithium-ion secondary battery (non-aqueous electrolyte secondary battery) and an all-solid-state secondary battery. The secondary battery can be used as a power supply of, for example, a battery electric vehicle (BEV), a hybrid electric vehicle (HEV), or a plug-in hybrid electric vehicle (PHEV). However, the coated active material particles and electrode obtained by the production method of the present disclosure are not limited to such vehicle applications and can be applied to any application.

Hereinafter, the present embodiment will be described with reference to examples, but the present embodiment is not limited thereto.

Preparation of Coated Active Material Particles

Coated active material particles were prepared by coating positive electrode active material particles composed of a NCA (lithium nickelate)-based positive electrode active material with a coating layer containing Nb (coating layer composed of LiNbO₃). The target value of the thickness of the coating layer was 10 nm. Here, it is preferable that the coating layer of the coated active material particles used in an all-solid-state battery have a thin thickness and have a coverage close to 100%.

Production of Positive Electrode

A positive electrode mixture containing an NCA-based positive electrode active material coated with LiNbO₃, a sulfide-based solid electrolyte, vapor grown carbon fibers, a PVdF (polyvinylidene fluoride)-based binder, and butyl butyrate was stirred by an ultrasonic dispersion device to prepare a positive electrode slurry. Here, the weight ratio of NCA-based positive electrode active material:sulfide-based solid electrolyte:vapor grown carbon fibers:PVdF binder was 88.2:9.8:1.3:0.7.

The positive electrode slurry was applied onto a positive electrode current collector foil (Al foil) by a blade method and the applied positive electrode slurry was dried on a hot plate at 100° C. for 30 minutes. Thereby, a positive electrode mixture layer was formed on the positive electrode current collector foil to obtain a positive electrode.

SEM Observation

### Example 1

For the positive electrode obtained above (the positive electrode mixture layer with a positive electrode current collector foil), from the side opposite to the positive electrode current collector foil, using an FE-SEM (SU8000, commercially available from Hitachi High-Tech Corporation), an SEM image of the positive electrode mixture layer was acquired under the following observation conditions.

Observation Conditions
emitting voltage: 0.2 kV (retarding mode)
accelerating voltage: 0.7 keV
retarding voltage: 1.5 keV

Image Analysis of SEM Image

Of 256 gradations in the particle image with a field of view (0.2 μm×0.2 μm) at a magnification of 2,500×, a part having a gradation number of 160 to 255 was white (no coating layer) and a part having a gradation number of less than 160 was black (with a coating layer), and it was determined whether there was a coating layer.

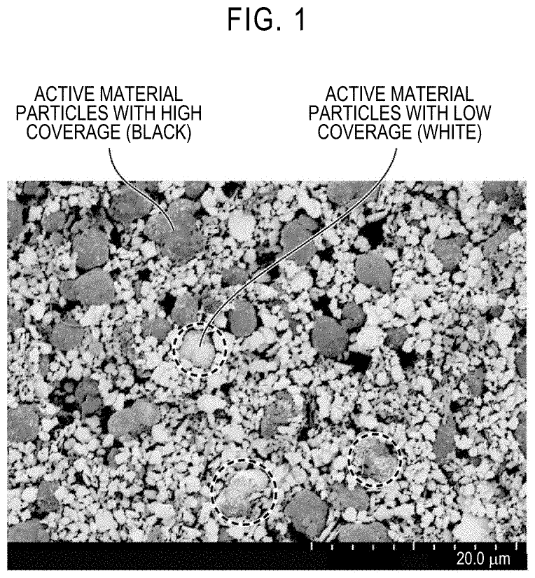

FIG. 1 shows the SEM image obtained in Example 1. In addition, FIG. 2 shows a partially enlarged view of the SEM image obtained in Example 1.

From the SEM images shown in FIG. 1 and FIG. 2, it can be understood that the contrast difference between the coated part (coating layer) and the non-coated part (active material particles) is large, and the two can be distinguished by image analysis of SEM images.

Here, in the field of view at a magnification of 2,500× shown in FIG. 1, a total number of active material particles was 43, and the number of active material particles with a low coverage (white active material particles) was 3. Accordingly, the proportion of active material particles with a high coverage (black active material particles) to the total number of active material particles was calculated to be 93%.

In this manner, when the proportion of the active material particles with a high coverage was calculated, based on the proportion, for example, regarding the raw material powder of the coated active material particles or the electrode produced using the same (electrode mixture layer), it was possible to evaluate whether the coating state of the active material particles was favorable or poor. Here, when the proportion of such active material particles with a high coverage was obtained, for example, it was preferable to calculate the proportion from the average value of 5 or more fields of view.

### Comparative Example 1

SEM observation was performed in the normal mode (backscattered electron image) (without using the retarding mode). Except for this, SEM observation of the positive electrode obtained above was performed in the same manner as in Example 1. FIG. 3 shows the SEM image obtained in Comparative Example 1.

From the SEM image shown in FIG. 3, it can be understood that the contrast difference between the coated part (coating layer) and the non-coated part (active material particles) was small and it was difficult to distinguish the two by image analysis of the SEM image.

In the coated active material particles to be observed by the SEM, the atomic number of Nb contained in the coating layer and the atomic number of elements constituting the positive electrode active material particles composed of the NCA-based positive electrode active material were relatively close. This is thought to have been caused by the fact that, since the difference in the atomic number of elements constituting the target sample mainly greatly influenced the contrast in the SEM image obtained in the normal mode, the contrast difference between the coated part and the non-coated part was small in the SEM image of Comparative Example 1.

On the other hand, as in Example 1, when SEM observation was performed in the retarding mode, the potential difference of the target sample mainly greatly influenced the contrast. It was thought that, in the coated active material particles, the atomic number of elements constituting the coating layer and the atomic number of elements constituting the positive electrode active material particles were relatively close, but the potential difference between the coating layer and the positive electrode active material particles was relatively large, and thus the contrast difference between the coated part and the non-coated part was relatively large in the SEM image of Example 1.

The embodiments and examples disclosed herein are only examples in all respects and should not be considered as restrictive. The scope of the present disclosure is not limited to the above description but is limited by the scope of the claims, and is intended to encompass equivalents to the scope of the claims and all modifications within the scope.

What is claimed is:

1. An evaluation method that evaluates a coating state of coated active material particles including active material particles and a coating layer that covers the surface of the active material particles, the method comprising acquiring an SEM image of the coated active material particles when a negative voltage is applied to the coated active material particles, detecting whether there is a coating layer on the surface of the active material particles based on a contrast in the SEM image, and evaluating the coating state.

2. The evaluation method according to claim 1, wherein an emitting voltage of primary electrons when the SEM image is acquired is 0.1 kV to 1.0 kV.

3. The evaluation method according to claim 1, wherein the coating layer contains a conductive material.

4. A method of producing coated active material particles including active material particles and a coating layer that covers at least a part of the surface of the active material particles, the method comprising:
a coating process in which a coating layer is formed on the surface of the active material particles to obtain the coated active material particles; and
an evaluating process in which a coating state of the coated active material particles obtained in the coating process is evaluated using the evaluation method according to claim 1.

5. A method of producing an electrode including an electrode mixture layer containing coated active material particles including active material particles and a coating layer that covers at least a part of the surface of the active material particles, the method comprising:
a process in which the electrode mixture layer containing the coated active material particles is formed; and
an evaluating process in which a coating state of the coated active material particles contained in the electrode mixture layer is evaluated using the evaluation method according to claim 1.
